(19) United States
(12) Patent Application Publication
(10) Pub. No.: US 2021/0409579 A1
(43) Pub. Date: Dec. 30, 2021

(54) CAMERA-MIRROR APPARATUS

(71) Applicant: PETER A. DAVIDSON, II, MIAMI, FL (US)

(72) Inventor: PETER A. DAVIDSON, II, MIAMI, FL (US)

(21) Appl. No.: 15/005,519

(22) Filed: Jan. 25, 2016

Related U.S. Application Data
(60) Provisional application No. 62/106,803, filed on Jan. 23, 2015.

(51) Int. Cl. H04N 5/225; H04N 5/232

(52) U.S. Cl. CPC H04N 5/2252; H04N 5/23222; G02B 5/08; H04N 5/2256; H04N 5/2259

(57) ABSTRACT

The invention features a camera-mirror apparatus, system and/or computer program product for its operational ability having a mirror with a built-in camera, a structure about and/or around the mirror, where the structure may be used for travel or traversal of the camera around the mirror and where the structure may be configured to enable angling of the camera. The apparatus, system may also include a lighting system about and/or around the mirror, and a processor, in communication with the structure and the lighting system, located within the camera-mirror apparatus and configured for coordinating the operation of the camera-mirror apparatus.

### FIELD OF THE INVENTION

The present invention relates, in general, to a mirror with a built-in camera.

### BACKGROUND OF THE INVENTION

Today, with the proliferation of mobile devices with cameras, people have taken to taking pictures of themselves. In doing so, their options are normally: (a) asking another person to take their picture or (b) take a “selfie”. Option A may not be possible or feasible especially where the person may be home alone or does not want to bother others to take the picture. Option B may also not be the best as the person's device may be visible in the picture and also may not be able to get the best angle for the person's picture.

As such, there is a need for an apparatus which is able to capture one's picture without help from another individual. There is also a need for an apparatus that would enable a person to take a picture of him/herself from different angles without having the person's device be in the picture. Further, there is a need for an apparatus that would enable a person to view their image first in say, a mirror, and then take their picture using their device remotely. That way, people will be able to take full pictures of themselves and be able to adapt any pose without the restrictions of having to hold the camera, phone or device and/or without imposing upon another to take the picture for them.

### SUMMARY OF THE INVENTION

The present invention contemplates a camera-mirror apparatus which enables one to take the best possible pictures of them either for public or private presentation. The apparatus, according to an aspect of an embodiment of the present invention, contemplates having front facing light (for optimal setup) to improve the quality of the picture (by providing ample illumination as needed).

An aspect of an embodiment of the present invention contemplates a camera-mirror apparatus which may include a mirror having a built-in camera, a structure about the mirror, where the structure may be used for travel of the camera around the mirror and where the structure may be configured to enable angling of the camera, a lighting system about the mirror, and a processor, in communication with the structure and the lighting system, located within the camera-mirror apparatus and configured for coordinating the operation of the camera-mirror apparatus. In an aspect of an embodiment of the present invention, the apparatus may have a plastic/metal casing. In one aspect, the structure may be located between the front mirror glass and the back panel of the mirror of the camera-mirror apparatus. In another aspect, the lighting system may also be located around the frame of the camera-mirror apparatus.

The mirror may come in various sizes and may include a power source such as battery power. One aspect contemplates use of mains power and thus incorporates the apparatus being configured to receive same. The apparatus may also include an indicator (such as a red light) that comes on when the apparatus is in use for security purposes. The apparatus may be used to capture individuals as they prepare or a group of people at an event.

In an aspect of an embodiment of the present invention, the structure may be adjusted and/or controlled remotely. In an aspect of an embodiment of the present invention, the structure may include a number of rods, railings and or similar structures which may be positioned, structured and/or configured to enable the camera to travel or traverse the length of the mirror. These rods, railings and/or similar structures may, in another aspect, be positioned, structured and/or configured to change the angle at which the picture or photo is taken.

In an aspect of an embodiment of the present invention, the lighting system may be controlled remotely.

In an aspect of an embodiment of the present invention, the processor may be configured to coordinate any one of the following: camera operations, lighting adjustment, structural angling & positioning, synchronization with one or more mobile device(s) via Bluetooth technology and/or other similar technology that enables communication between the processor and one or more mobile device(s), including wireless communication with the one or more mobile device(s). The processor's synchronization, in one aspect, may be with a mobile device(s)' application.

In an aspect of an embodiment of the present invention, the camera-mirror apparatus may further include a memory module, which in one aspect, may be in communication with the processor.

In an aspect of an embodiment of the present invention, the camera-mirror apparatus may further include on board code for implementing one or more or all of the camera-mirror operations.

In an aspect of an embodiment of the present invention, the lighting system may include lighting fixtures arranged around the camera-mirror apparatus. In one aspect, the lighting fixtures may be arranged in a horseshoe configuration around the top half of the camera-mirror apparatus. In another aspect, the apparatus may have rows of small lights built into the mirror. The lighting system may also be adjusted or controlled to be changed according to different skin tones, background lighting, color of one's outfit or outside lighting for optimal pictures. The lighting system could also be brightened or dimmed or have a “paparazzi” effect for the picture (synchronized flash).

In an aspect of an embodiment of the present invention, the camera may be configured to do any one or more of the following independent of the structure: focusing, positioning, angling.

In an aspect of an embodiment of the present invention, the structure may comprise of railings upon which the camera may be enabled to be affixed upon and glide around. This, in one aspect, may be made possible by way of a motorized carriage which may traverse the structure having the camera affixed or mounted upon it. The motorized carriage may also be controlled by way of the mobile device and/or the processor in order to move the camera to effect a certain focus, angle, position etc as necessary for a particular picture configuration.

In an aspect of an embodiment of the present invention, the structure may be arranged to provide the apparatus with optimal camera positioning, angling and operational capability.

Another aspect of an embodiment of the present invention contemplates a system for image capture, which may include a combination camera-mirror apparatus, a processor, in communication with, and located within, the camera-mirror apparatus where the processor may be configured for coordinating operations of the camera-mirror apparatus, one or more mobile device(s) in communication with the processor, the one or more mobile device(s) being configured to control the camera-mirror apparatus, one or more communication medium for enabling communication between the processor and the one or more mobile device, a memory module, in communication with the processor, and computer code for enabling implementation of all operations of the camera-mirror apparatus.

In yet another aspect of an embodiment of the present invention, the camera-mirror apparatus may include a structure about and around the camera-mirror apparatus, where the structure may be configured to enable travel of the camera around the mirror and where the structure may be configured to enable angling of the camera.

In yet another aspect of an embodiment of the present invention, the camera may be enabled to travel or traverse the structure by way of a motorized carriage.

In yet another aspect of an embodiment of the present invention, the motorized carriage may be controlled by either or both of the processor and/or the mobile device.

In yet another aspect of an embodiment of the present invention, the camera-mirror apparatus may include a lighting system about the camera-mirror apparatus. In one aspect, the lighting system may be located around the mirror.

In yet another aspect of an embodiment of the present invention, the computer code may be accessible by the processor for executing operations of the camera-mirror apparatus.

In yet another aspect of an embodiment of the present invention, the mobile device may include a local processor for enabling its communication and operations with the camera-mirror apparatus.

A further aspect of an embodiment of the present invention contemplates computer program product which may include a computer usable medium having control logic stored on it for causing a computer processor to enable operation of a camera-mirror apparatus, and with the control logic including computer readable program code for enabling: image capture by the camera, movement of the camera around the camera-mirror apparatus, remote control of the camera-mirror apparatus by one or more mobile device, control of a lighting system employed by the camera-mirror apparatus, and capture & transmission of an image reflected within the mirror onto the display of the one or more mobile device.

A further aspect of an embodiment of the present invention may include computer readable program code for adjusting the lighting output of the lighting system.

A further aspect of an embodiment of the present invention may include computer readable program code for enabling synchronization between the one or more mobile device and the processor.

A further aspect of an embodiment of the present invention may include computer readable program code for mechanical positioning, which may include, in one aspect of an embodiment of the present invention, angling of the camera.

A further aspect of an embodiment of the present invention may include comprising computer readable program code for controlling a motorized carriage used to transport the camera around the camera-mirror apparatus.

Additional aspects, objectives, features and advantages of the present invention will become apparent from the following description of the preferred embodiments with reference to the attached drawings. The invention has been described in detail with particular reference to certain preferred embodiments thereof, but it will be understood that variations and modifications can be effected within the spirit and scope of the invention.

### BRIEF DESCRIPTION OF THE DRAWINGS

FIG. 1A illustrates a camera-mirror apparatus, according to an aspect of an embodiment of the present invention.

FIG. 1B illustrates details of the camera-mirror apparatus camera, according to an aspect of an embodiment of the present invention.

FIG. 2 illustrates a camera-mirror apparatus, an operator and a mobile device, according to an aspect of an embodiment of the present invention.

FIG. 3 illustrates a camera-mirror apparatus with a lighting system, according to an aspect of an embodiment of the present invention.

FIG. 4 illustrates an operational module of a camera-mirror apparatus, according to an aspect of an embodiment of the present invention.

### DETAILED DESCRIPTION OF THE INVENTION

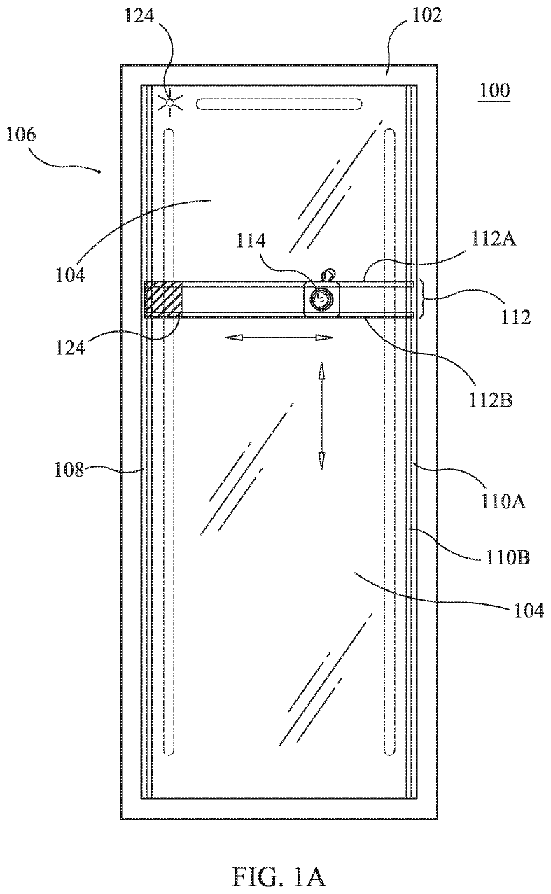

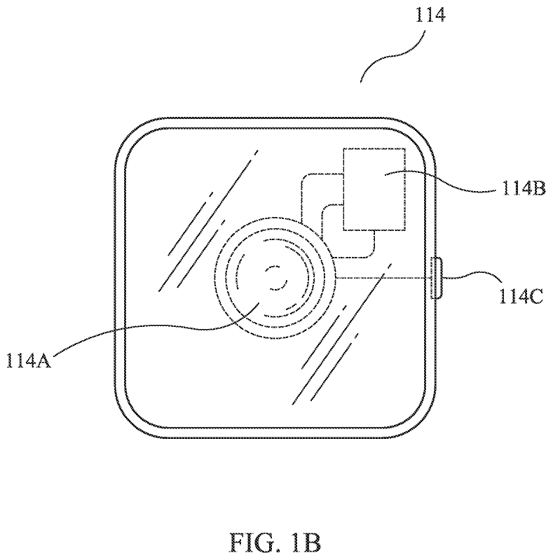

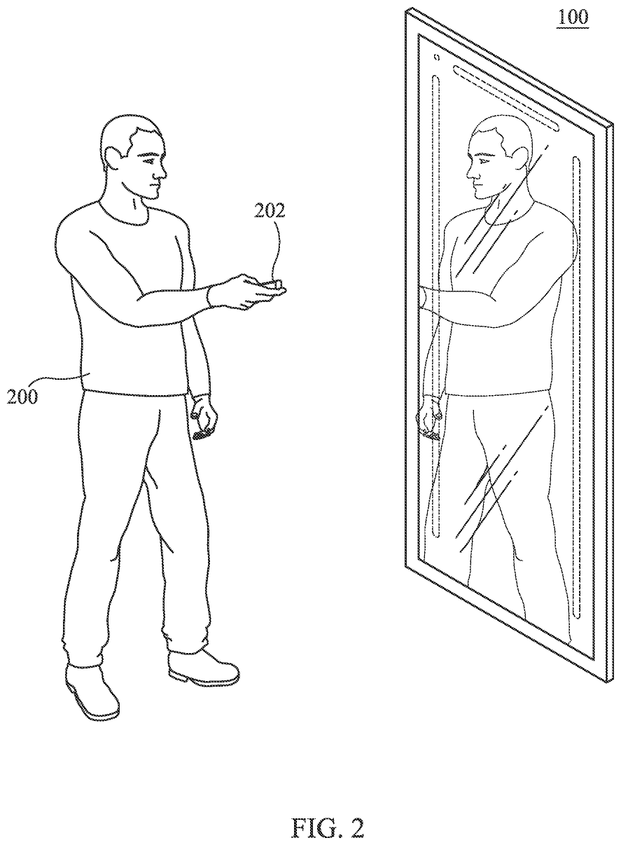

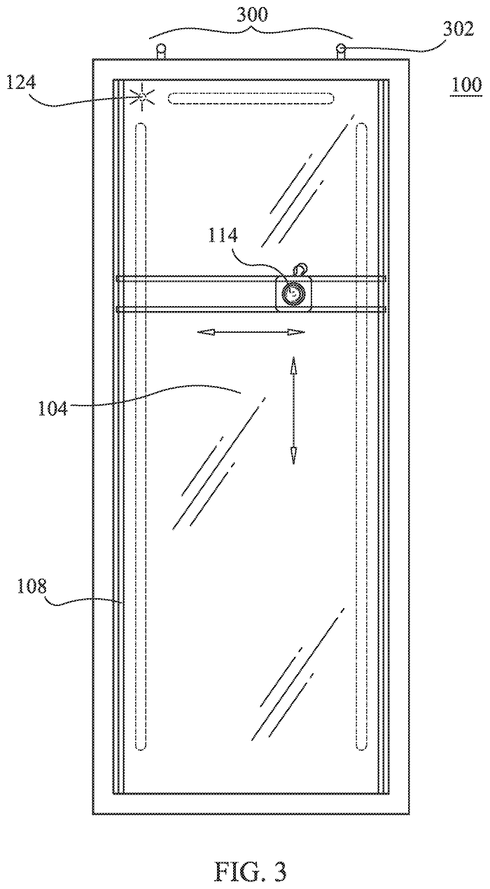

Referring now to FIGS. 1A through 3, different views of a camera-mirror apparatus or system 100 and/or its elements are shown according to aspects of embodiments of the present invention. Camera-mirror apparatus or system 100 is shown with mirror frame 102 which surrounds or encloses, according to one aspect of an embodiment of the present invention, mirror glass 104. In one aspect of an embodiment of the present invention, mirror frame 102 may be made of any number of different materials including wood, plastic, etc. which surround mirror glass 104. Camera-mirror apparatus may have a mirror back or back panel 106 which backs camera-mirror apparatus 100. In between mirror glass 104 and back panel 106, in one aspect of an embodiment of the present invention, is track structure 108 which may include vertical track 110 and horizontal track 112 along which camera 108 may be allowed to run along where vertical track 110 may include vertical rods, railings and or similar structures 110A and 110B and where horizontal track 112 may include horizontal rods, railings and or similar structures 112A and 112B. In one aspect of an embodiment of the present invention, camera 114 may run with or within a motorized carriage 116 (not shown) along track structure 108. Camera 114 may, in aspect(s) of embodiment(s) of the present invention, include any one or more of: lens 114A, battery 114B and/or activation button 114C for manually taking a picture.

Track structure 108 may take the form of different configurations, the vertical-horizontal structure shown here being a representative configuration. As such, different configurations such as a circular, elliptical, curved, etc. track structures and/or a combination of different configurations are also envisioned according to aspect(s) of embodiment(s) of the present invention. Track structure 108 may also be structurally configured to enable different positioning of camera 114 such as angling etc. Track structure 108 may, according to an aspect of an embodiment of the present invention, be structurally enabled for at least one side of track structure 108 to tilt forward toward the front glass 104 of camera-mirror apparatus 100. In another aspect of an embodiment of the present invention, track structure 108 may be enabled to rotate about an axis. Track structure 108 may, in another aspect of an embodiment of the present invention, be adjusted and/or controlled remotely using one or more mobile device(s) 202. Mobile device(s) 202 may be any electronic device enabled to receive and/or transmit communications such as a computer, mobile phone, tablet, remote control, etc. Communication between mobile device(s) 202 and other components of system 100 may be effected by way of Bluetooth technology and/or any other similar technologies.

In another aspect of an embodiment of the present invention, rods/railings/structures 110A, 110B, 112A and 112B may be positioned, structurally enabled and/or configured to enable camera 114 (and or carriage 116) to travel or traverse the length and/or width of the mirror. The rods/railings/structures 110A, 110B, 112A and 112B may also, in another aspect of an embodiment of the present invention, be positioned, structurally enabled and/or configured to change the angle at which a photo may be taken by camera 114.

Carriage 116 may include a number of wheels or bearings along with a motor all of which enable its motion along grooves of rods/railings/structures 110A, 110B, 112A and 112B. Camera 114, being behind mirror glass 104 may be enabled to take pictures of a user or operator 200 and he or she faces camera-mirror apparatus 100. In an aspect of an embodiment of the present invention, motorized carriage 116 may include any one of an on board processor 120 (not shown), a transmitter, and/or a transceiver 122 (not shown) which enables carriage 116 to receive positioning instructions while also enabling motorized carriage 116 to transmit its location and state. Horizontal track 112, in one aspect of an embodiment of the present invention, may also include a motorized carriage 124 which may include a motor and wheels/bearings that enable translation of horizontal track 112 up and down vertical track 110. Motorized carriage 124 may also include an on board processor (not shown). In another aspect of an embodiment of the present invention, motorized carriage 124 may also include any one of a transmitter or transceiver (not shown) which enables horizontal track 112 to receive positioning instructions while also enabling motorized carriage 124 to transmit it location and state.

Camera-mirror apparatus 100 may be powered by way of any one or both of the mains and/or a battery (not shown). Camera-mirror 100 thus may have either a main plug and/or adapter 118 (not shown). Camera-mirror apparatus 100 may also include a red light 116 to indicate that camera-mirror apparatus 100 is on or in operation.

Camera-mirror apparatus 100 may include lighting system 300 which, in turn may include lighting fixtures 302 arranged around camera-mirror apparatus 100. In one aspect, lighting fixtures 302 may be arranged in a horseshoe configuration around the top half of camera-mirror apparatus 100. In another aspect, apparatus 100 may have rows of small lights built in between glass 104 and back panel 106. In another aspect, they may be built in to mirror glass 104. Lighting system 300 may also be adjusted, controlled or changed according to different skin tones, background lighting, and color of one's outfit or outside lighting for optimal pictures. Lighting system 300 could also be brightened or dimmed or have a “paparazzi” effect for the picture. In an aspect of an embodiment of the present invention, lighting system 300 may be controlled remotely using mobile device 202. In an aspect of an embodiment of the present invention, camera-mirror apparatus 100 may also include an indicator (such as a red light) 126 that comes on when apparatus 100 is in use for security purposes.

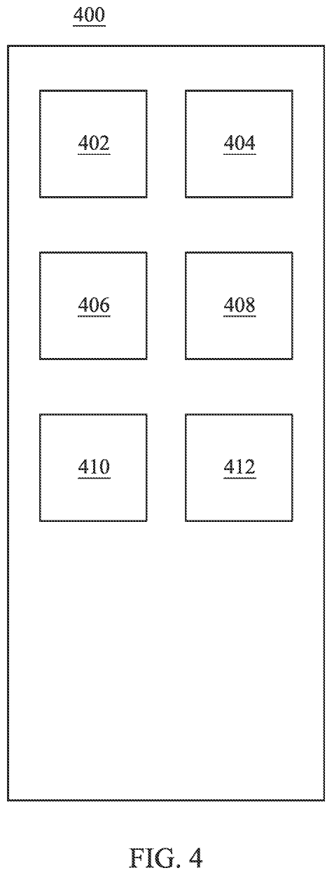

Referring now to FIG. 4, an operational module 400 of camera-mirror apparatus/system 100 is shown according to an aspect of an embodiment of the present invention. In an aspect of an embodiment of the present invention, the modules disclosed may be self-contained computer hardware. In another aspect of an embodiment of the present invention, they may be computer hardware on a designated computer chip or separate computer chips. In a further aspect of an embodiment of the present invention, the modules may be hardware resident on one chip, component, separate components or any combination thereof. Operational module 400 may be located within camera-mirror apparatus 100. In one aspect, it may be located between glass 104 and back panel 106.

Operational module 400 may include, in an aspect of an embodiment of the present invention, processor 402, code 404 for implementing, upon execution by processor 402, one or more or all of the camera-mirror operations, memory 406 for storage of operations, data etc. associated with camera-mirror apparatus 100, lighting module 408 for coordinating operations by lighting system 300 in conjunction with processor 402, motorized carriage module 410 for coordinating location and positioning of motorized carriage 116 and/or horizontal track carriage 124 and wireless module 412 for enabling remote control of elements of camera-mirror 100 by mobile device(s) 202 and for transmitting and/or receiving wired and/or wireless communications from elements of camera-mirror apparatus 100 (such as motorized carriage 116 and/or horizontal track carriage 124, according to one aspect). Wireless module 412, in one aspect of an embodiment of the present invention, may enable wired and/or wireless communication using a between elements of camera-mirror apparatus 100. In another aspect of an embodiment of the present invention, wireless module may be configured to enable communication between elements of camera-mirror apparatus/system 100 using Bluetooth technology and/or other similar communication technologies. Motorized carriage module 410, in one aspect, operates to convert the communications/signals/commands received from processor 402 into mechanical operations of the respective carriages 116 and 124. For instance, when operator 200 enters on mobile device(s) 202 a command for a picture, the command is sent via wireless medium to wireless module 410 which receives the command and transmits the same to processor 402 which, upon receipt, relays the command to motorized carriage module 410. The command is then converted and carriage 116 is activated to move to a particular location as dictated by the command. In one aspect of an embodiment of the present invention, the command received by the processor 402 may require processor 402 to execute code 404 in order to generate a mechanized command which is then sent to module 410.

Processor 402 may be configured to coordinate any one of the following: camera operations, lighting adjustment, structural angling & positioning, synchronization with one or more mobile device 202, communication between processor 402 and one or more mobile device 202, including wireless communication with one or more mobile device(s) 202. Processor 402's synchronization, in one aspect, may be with an application on mobile device(s) 202. In yet another aspect of an embodiment of the present invention, processor 402 may be configured to perform others tasks not undertaken by the other modules.

Lighting system 300 may, in another aspect of an embodiment of the present invention, be utilized as a flash for camera 114. Such flash operations of lighting system 300 may be implemented by coordination of operations by and between processor 402 and lighting module 408 where lighting module 408 operates to convert the communications/commands received from processor 402 in order to implement such communications/commands by way of the specific operation of lighting system 300 such as flash, dimming, increasing lumen output etc. A further aspect of an embodiment of the present invention contemplates computer program product which may include a computer usable medium having control logic 404 stored on it for causing processor 402 to enable operation of camera-mirror apparatus 100, and with the control logic including computer readable program code for enabling: image capture by camera 114, movement of camera 114 (by way of carriage 116 and track structure 108) around camera-mirror apparatus 100, remote control of camera-mirror apparatus 100 by one or more mobile device(s) 202, control of lighting system 300 and capture & transmission of an image reflected within the mirror onto the display of one or more mobile device(s) 202.

A further aspect of an embodiment of the present invention may include computer readable program code for adjusting the lighting output of lighting system 300, enabling synchronization between one or more mobile device(s) 202 and processor 402, mechanical positioning, which may include, in aspects of embodiments of the present invention: angling of the camera, positioning of track structure 108, operation and positioning of motorized carriage 116 and horizontal motorized carriage 124.

The invention has been described in detail with particular reference to certain preferred embodiments thereof, but it will be understood that variations and modifications can be effected within the spirit and scope of the invention.

What is claimed is:

1. A camera-mirror apparatus comprising:
a mirror having a built-in camera;
a structure about the mirror, wherein the structure is used for travel of the camera around the mirror and wherein the structure is configured to enable angling of the camera;
a lighting system about the mirror; and
a processor, in communication with the structure and the lighting system, located within the camera-mirror apparatus and configured for coordinating the operation of the camera-mirror apparatus.

2. The camera-mirror apparatus of claim 1 wherein the structure may be adjusted remotely.

3. The camera-mirror apparatus of claim 1, wherein the lighting system may be controlled remotely.

4. The camera-mirror apparatus of claim 1 wherein the processor is configured to coordinate any one of the following: camera operations, lighting adjustment, structural angling & positioning, synchronization with at least one mobile device, communication between the processor and at least one mobile device.

5. The camera-mirror apparatus of claim 1 further comprising a memory module.

6. The camera-mirror apparatus of claim 1 further comprising on board code for implementing at least one of the camera-mirror operations.

7. The camera-mirror apparatus of claim 1, wherein the lighting system comprises of lighting fixtures arranged around the camera-mirror apparatus.

8. The camera-mirror apparatus of claim 7, wherein the lighting fixtures are arranged in a horseshoe configuration around the top half of the camera-mirror apparatus.

9. The camera-mirror apparatus of claim 1, wherein the camera is configured to do any of the following independent of the structure: focusing, positioning, angling.

10. The camera-mirror apparatus of claim 1 wherein the structure comprises of railings.

11. The camera-mirror apparatus of claim 10 wherein the structure is arranged to provide the apparatus with optimal camera positioning, angling and operational capability.

12. The camera-mirror apparatus of claim 1 further comprising a motorized carriage for traversing the camera around the structure.

13. The camera-mirror apparatus of claim 12, wherein the motorized carriage is controlled by the mobile device.

14. The camera-mirror apparatus of claim 12, wherein the motorized carriage is controlled by the processor.

15. A system for image capture, comprising:
a combination camera-mirror apparatus;
a processor, in communication with, and located within, the camera-mirror apparatus wherein the processor is configured for coordinating operations of the camera-mirror apparatus;
at least one mobile device in communication with the processor, the at least one mobile device being configured to control the camera-mirror apparatus;
at least one communication medium for enabling communication between the processor and the at least one mobile device;
a memory module, in communication with the processor; and
computer code for enabling implementation of all operations of the camera-mirror apparatus.

16. The system of claim 15 wherein the camera-mirror apparatus comprises of a structure about and around the camera-mirror apparatus, wherein the structure is configured to enable travel of the camera around the mirror and wherein the structure is configured to enable angling of the camera.

17. The system of claim 16 wherein the camera is enabled to travel or traverse the structure by way of a motorized carriage.

18. The system of claim 16 wherein the motorized carriage may be controlled by any one of:
the processor or the mobile device.

19. The system of claim 15 wherein the camera-mirror apparatus comprises of a lighting system about the camera-mirror apparatus.

20. The system of claim 15 wherein the computer code is accessible by the processor for executing operations of the camera-mirror apparatus.

21. The system of claim 15 wherein the mobile device comprises of a local processor for enabling its communication and operations with the camera-mirror apparatus.

22. A computer program product comprising a computer usable medium having control logic stored therein for causing a computer processor to enable operation of a camera-mirror apparatus, the control logic comprising:
computer readable program code for enabling image capture by the camera;
computer readable program code for enabling movement of the camera around the camera-mirror apparatus;
computer readable program code for enabling remote control of the camera-mirror apparatus by at least one mobile device;
computer readable program code for enabling control of a lighting system employed by the camera-mirror apparatus; and
computer readable program code for enabling capture and transmission of an image reflected within the mirror onto the display of the at least one mobile device.

23. The computer program product according to claim 22, further comprising computer readable program code for adjusting the lighting output of the lighting system.

24. The computer program product according to claim 22, further comprising computer readable program code for enabling synchronization between the at least one mobile device and the processor.

25. The computer program product according to claim 22, further comprising computer readable program code for mechanical positioning of the camera.

26. The computer program product according to claim 22, further comprising computer readable program code for controlling a motorized carriage used to transport the camera around the camera-mirror apparatus.
